(19) United States
(12) Patent Application Publication
(10) Pub. No.: US 2014/0078171 A1
(43) Pub. Date: Mar. 20, 2014

(54) REPRODUCTION DEVICE

(71) Applicant: Panasonic Corporation, Osaka (JP)

(72) Inventors: Kazufumi MIYATAKE, Osaka (JP); Yoshio KAWAKAMI, Osaka (JP); Masahiro OASHI, Yamanashi (JP)

(73) Assignee: Panasonic Corporation, Osaka (JP)

(21) Appl. No.: 14/082,754

(22) Filed: Nov. 18, 2013

Related U.S. Application Data
(63) Continuation of application No. PCT/JP2012/002712, filed on Apr. 19, 2012.

(30) Foreign Application Priority Data
May 20, 2011 (JP) 2011-114210

(51) Int. Cl. G06T 11/20

(52) U.S. Cl. CPC G06T 11/20
USPC 345/619

(57) ABSTRACT

A reproduction device includes: a memory; a drawing processing unit that draws pieces of element data onto a screen according to instruction data which is received from a server, includes the pieces of element data, and instructs to draw the pieces of element data; and a cache control unit that generates, when the instruction data instructs application of a decoration method to the pieces of element data to be drawn, a piece of image data including the pieces of element data keeping positional relationships among them as drawn, and writes the generated piece of image data into the memory. When the instruction data instructs application of the decoration method to the pieces of element data to be drawn, the drawing processing unit applies the decoration method to the piece of image data stored in the memory, and draws the decorated image data onto the screen.

### CROSS REFERENCE TO RELATED APPLICATIONS

This is a continuation application of PCT Patent Application No. PCT/JP2012/002712 filed on Apr. 19, 2012, designating the United States of America, which is based on and claims priority of Japanese Patent Application No. 2011-114210 filed on May 20, 2011. The entire disclosures of the above-identified applications, including the specifications, drawings and claims are incorporated herein by reference in their entirety.

### FIELD

One or more exemplary embodiments disclosed herein relate to reproduction devices, such as Consumer Electronics (CE), which cause reproducible data provided as Internet services to be displayed at a high speed.

### BACKGROUND

In general, CEs, such as portable information terminals and tablet computers, have less hardware resources than those of personal computers (PC). For example, CEs have lower CPU performance and a smaller memory capacity in comparison to PCs. If a CE runs an application program executable in PCs, it is generally necessary to simplify display of the application program to reduce hardware resources.

Among such CEs, in recent years, reproduction devices having Blu-ray Disc Read Only Memory (BD-ROM) reproduction function including Java® virtual machine have been widely used. It is therefore considered that CEs have a capability enough to run a Java® virtual machine. However, since there is no CE having a function equivalent to an HyperText Markup Language (HTML) browser executable in PCs, it is generally considered that CEs are not capable of running an HTML browser executable in PCs.

In the meantime, recently, there are popular services (hereinafter, referred to collectively as “Internet service”) for providing functions of, for example, distributing and sharing video data, audio data, photograph data, and the like via the Internet, by utilizing functions of an HTML browser executable in PCs and functions of programs (generally-called plug-in or add-on) cooperating with the HTML browser. In addition, there are increased Internet services for performing animation display of image data (vertical/horizontal scrolling or rotating of the image data) on an HTML browser by utilizing Cascading Style Sheet (CSS) 3 that is an example of plug-in or add-on, thereby improving visual effects.

If a CE is to reproduce data (hereinafter, referred to as “Internet service data”) provided as Internet service for PCs, the CE has a difficulty, as described above, in running directly an HTML browser and plug-in which are generally executed by PCs or in running a program having a function equivalent to the HTML browser and the plug-in due to its insufficient hardware resources. It is therefore necessary to address the difficulty in a way different from the way used for reproducing the Internet service data by PCs. More specifically, a program dedicated to reproduce certain Internet service data is executed on the CE without using the HTML browser. The dedicated program reproduces the Internet service data by communicating directly with a server (hereinafter, referred to as a “service server”) that has provided the Internet service data. Furthermore, since the dedicated program is specialized in reproducing the Internet service data, it is possible to minimize hardware resources to be used in the reproduction. As a result, even the CE can reproduce the Internet service data.

However, as described above, when a CE having a less hardware capability than that of PCs reproduces Internet service data generated for PCs, the problem of the less capability comes up to the surface. For example, the CE fails to smoothly draw image data, thereby preventing the user from smoothly operating on a screen.

In order to solve the above problem, Patent Literature 1 discloses a method of smoothly performing screen scrolling by a client. More specifically, a server is notified of a screen size of a client, then caches an image to be next displayed by scrolling the screen of the client as a screen image adjusted to the screen size, and then transmits the cached screen image to the client when the screen of the client is actually scrolled. As a result, a data amount in communications is reduced, and it therefore possible to smoothly scroll the screen of the client.

### CITATION LIST

### Patent Literature

[Patent Literature 1] Japanese Unexamined Patent Application Publication No. 2010-257148

### SUMMARY

### Technical Problem

However, although the conventional art can smoothly execute a scroll function of a browser, the conventional art is incapable of performing, at a high speed, recently-popular animation display of image data in an HTML browser by using CSS3 or the like.

One non-limiting and exemplary embodiment provides to a reproduction device capable of smoothly performing animation display of image data in an HTML browser by using CSS3 or the like.

### Solution to Problem

In one general aspect, the techniques disclosed here feature a reproduction device that reproduces pieces of element data to display the pieces of element data on a screen, the pieces of element data each being image data or character data, the reproduction device including: a memory; a drawing processing unit configured to draw pieces of element data onto the screen according to instruction data received from a server, the instruction data including the pieces of element data and instructing to draw the pieces of element data; and a cache control unit configured to, when the instruction data instructs application of a decoration method to the pieces of element data to be drawn, (i) generate a piece of image data that includes the pieces of element data which keep a positional relationship between the pieces of element data as drawn, and (ii) write the generated piece of image data into the memory, wherein the drawing processing unit is configured to, when the instruction data instructs application of the decoration method to the pieces of element data to be drawn, (i) apply the decoration method instructed in the instruction data to the piece of image data stored in the memory, and (ii) draw the decorated image data onto the screen.

With the above structure, displaying, on a screen, one piece of image data stored in a memory can result in the same piece of image data as generated by displaying plural pieces of element data independently on the screen. A decoration operation is performed only once by decorating a single piece of image data. As a result, it is possible to draw plural pieces of element data at a high speed. It is therefore possible to achieve smooth animation display, when animation display is performed for pieces of element data in an HTML browser by using CSS3 or the like. As a result, a usability is improved.

It is also possible that when the instruction data instructs application of a same decoration method to all the pieces of element data, the cache control unit is configured to (i) generate one piece of image data that includes the pieces of element data which keep the positional relationship as drawn, and (ii) write the generated piece of image data into the memory, and when the instruction data instructs application of the same decoration method to all the pieces of element data, the drawing processing unit is configured to (i) apply the same decoration method to the piece of image data stored in the memory, and (ii) draw the decorated pieces of image data onto the screen.

Since the same decoration is designated by instruction data to all of plural pieces of element data, the decoration is applied to one piece of image data stored in the memory only once. This can result in the same image as generated by decorating the pieces of element data separately. It is therefore possible to decorate the pieces of element data at a high speed. As a result, it is possible to draw the pieces of element data at a high speed, thereby improving a usability.

It is further possible that if the positional relationship between the pieces of element data is not changed when different decoration methods instructed in the instruction data are applied to the respective pieces of element data in drawing the pieces of element data, the cache control unit is configured to (i) generate one piece of image data that includes the pieces of element data which keep the positional relationship as drawn, and (ii) write the generated piece of image data into the memory, and

if the positional relationship between the pieces of element data is not changed when the different decoration methods instructed in the instruction data are applied to the respective pieces of element data in drawing the pieces of element data, the drawing processing unit is configured to (i) apply any one of the different decoration methods instructed for the pieces of element data to the piece of image data stored in the memory, and (ii) draw the decorated piece of image data onto the screen.

Even if different pieces of instruction data designate different decoration methods to plural pieces of element data, as long as the decoration methods keep positional relationships among the pieces of element data unchanged, one piece of image data stored in the memory is decorated only once to generate the same image as generated by decorating the pieces of element data separately. It is therefore possible to decorate the pieces of element data at a high speed. As a result, it is possible to draw the pieces of element data at a high speed, thereby improving a usability.

It is still further possible that when the instruction data instructs application of decoration methods to the respective pieces of element data by performing parallel translation on the pieces of element data with a same move width and with a same time duration required for the move, the cache control unit is configured to (i) generate one piece of image data that includes the pieces of element data which keep the positional relationship as drawn, and (ii) write the generated piece of image data into the memory, and when the instruction data instructs application of the decoration methods to the respective pieces of element data by performing the parallel translation on the pieces of element data with the same move width and with the same time duration required for the move, the drawing processing unit is configured to (i) apply any one of the decoration methods instructed for the pieces of element data to the piece of image data stored in the memory, and (ii) draw the decorated piece of image data onto the screen.

It is still further possible that when the instruction data instructs application of decoration methods to the respective pieces of element data by scaling the pieces of element data in a same coordinate axis direction for a same time duration, the cache control unit is configured to (i) generate one piece of image data that includes the pieces of element data which keep the positional relationship as drawn, and (ii) write the generated piece of image data into the memory, and when the instruction data instructs application of the decoration methods to the respective pieces of element data by scaling the pieces of element data in the same coordinate axis direction for the same time duration, the drawing processing unit is configured to (i) apply any one of the decoration methods instructed for the pieces of element data to the piece of image data stored in the memory, and (ii) draw the decorated piece of image data onto the screen.

It is still further possible that when the instruction data instructs application of decoration methods to the respective pieces of element data by rotating the pieces of element data with respect to same coordinates on a same coordinate axis for a same time duration, the cache control unit is configured to (i) generate one piece of image data that includes the pieces of element data which keep the positional relationship as drawn, and (ii) write the generated piece of image data into the memory, and when the instruction data instructs application of the decoration methods to the respective pieces of element data by rotating the pieces of element data with respect to the same coordinates on the same coordinate axis for the same time duration, the drawing processing unit is configured to (i) apply any one of the decoration methods instructed for the pieces of element data to the piece of image data stored in the memory, and (ii) draw the decorated piece of image data onto the screen.

It should be noted that the general and specific aspect disclosed above may be implemented not only as the reproduction device including the above characteristic units, but also as a reproduction method including steps performed by the characteristic units in the reproduction device. The general and specific aspect disclosed above may be implemented also as: a program causing a computer to function as the characteristic units in the reproduction device; and a program causing a computer to execute the characteristic steps of the reproduction method. Of course, the program can be distributed via a non-transitory computer-readable recording medium such as a Compact Disc-Read Only Memory (CD-ROM) or via a communication network such as the Internet.

### Advantageous Effects

The reproduction device according to one or more exemplary embodiments or features disclosed herein can offer smooth animation display of image data in an HTML browser by using CSS3 or the like. As a result, a usability is improved.

### BRIEF DESCRIPTION OF DRAWINGS

These and other objects, advantages and features of the present disclosure will become apparent from the following description thereof taken in conjunction with the accompanying drawings that illustrate a specific embodiment.

FIG. 1 is an external configuration diagram of a home theater system that includes an Internet service reproduction device according to an embodiment.

FIG. 2 is a diagram showing an example of connecting the reproduction device to an Internet service server.

FIG. 3 is a diagram showing an example of pieces of data stored in the Internet service server.

FIG. 4 is a functional block diagram of the reproduction device.

FIG. 5 is a block diagram showing a hardware structure of the reproduction device.

FIG. 6 is a diagram showing an example of HTML data.

FIG. 7 is a diagram showing an example of CSS3 data.

FIG. 8 is a flowchart of processing from start of animation display to the first drawing.

FIG. 9 is a diagram showing the state where the HTML data in FIG. 6 is displayed by a browser.

FIG. 10 is a diagram showing the state after a JavaScript interpretation execution unit changes a part of the HTML data in FIG. 6.

FIG. 11 is a diagram of pieces of image element data cached as a single piece of image data in a memory.

FIG. 12 is a diagram showing the state where the HTML data in FIG. 10 is displayed as animation display by a browser.

FIG. 13 is a flowchart of processing from the second drawing to completion of the animation display in the animation display.

FIG. 14 is a diagram showing an example of HTML data.

FIG. 15 is a diagram showing an example of HTML data.

FIG. 16 is a diagram showing an example of CSS3 data.

FIG. 17 is a diagram showing an example of a functional structure of a television set to which the present disclosure is implemented.

### DESCRIPTION OF EMBODIMENT

The following describes an embodiment according to the present disclosure with reference to the drawings.

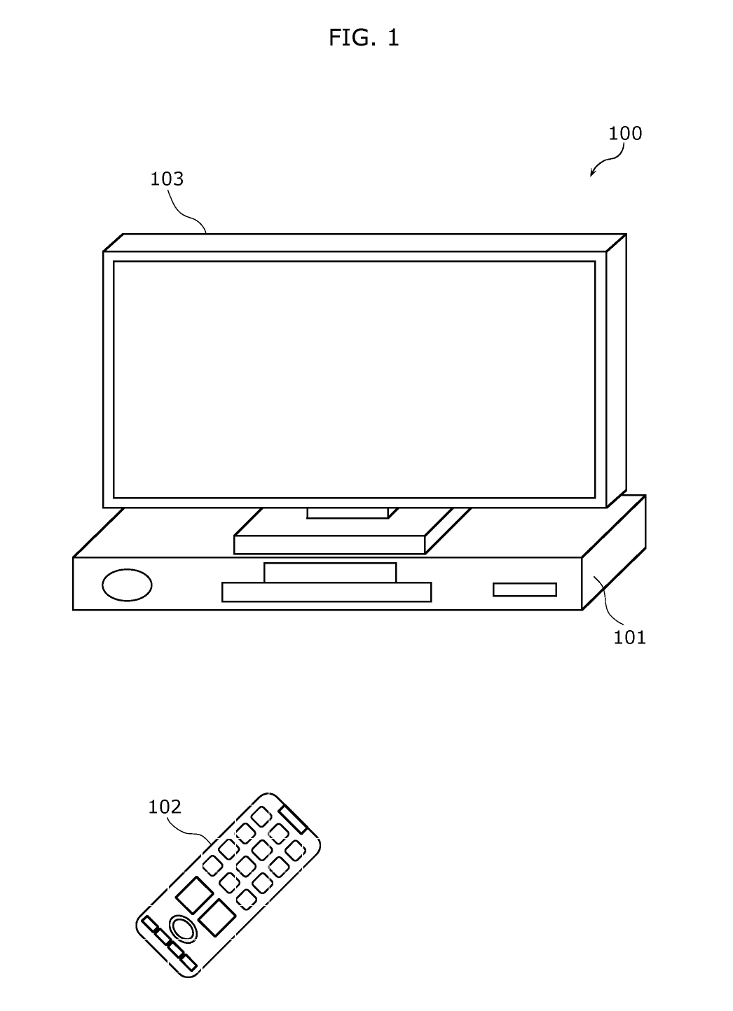

FIG. 1 is an external configuration diagram of a home theater system that includes an Internet service reproduction device according to the present embodiment.

The home theater system 100 shown in FIG. 1 includes a reproduction device 101, a remote controller 102, and a display device 103. The reproduction device 101 corresponds to an Internet service reproduction device (for example, a BD-ROM player or a BD-ROM recorder) according to the present embodiment. It should be noted that the display device 103 (for example, a television set) may be included in the Internet service reproduction device according to the present embodiment.

The reproduction device 101 is used to supply movies to the home theater system 100. The reproduction device 101 reproduces pieces of element data, such as image data and character data, to display the pieces of element data on a screen. For example, the reproduction device 101 obtains content items, such as a movie, from a removable medium such as a Secure Digital (SD) card, a recording medium such as a BD-ROM, or the Internet. Then, according to instructions from the remote controller 102, the reproduction device 101 causes video to be displayed on the display device 103 and causes audio to be outputted from a speaker (not shown). It should be noted that the reproduction device 101 includes a receiving unit or the like to receive instruction data from the remote controller 102. The remote controller 102 has various buttons and the like.

The remote controller 102 transmits a piece of instruction data corresponding to a button pressed by a user to the reproduction device 101 and the display device 103.

The display device 103 displays video processed by the reproduction device 101. The display device 103 includes the speaker (not shown). The speaker outputs audio processed by the reproduction device 101. It should be noted that the reproduction device 101 may include the speaker.

As described above, the Internet service reproduction device according to the present embodiment is used for home theater systems and the like.

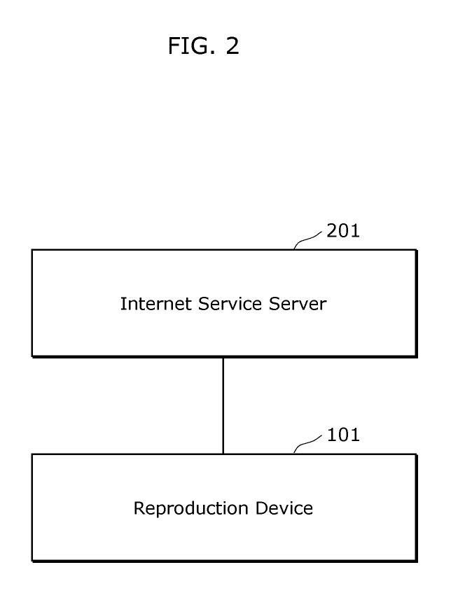

FIG. 2 is a diagram showing an example of a system that includes the Internet service reproduction device according to the present embodiment and a server that provides services. The reproduction device 101 is connected to the Internet service server 201 via a network such as the Internet, so that the reproduction device 101 can exchange data with the Internet service server 201. It should be noted that the method of connecting the reproduction device 101 to the Internet service server 201 is not limited to the Internet, but may be any method as long as data can be exchanged between the reproduction device 101 and the Internet service server 201. For example, the reproduction device 101 and the Internet service server 201 may be connected with each other via a Local Area Network (LAN) or an Universal Serial Bus (USB).

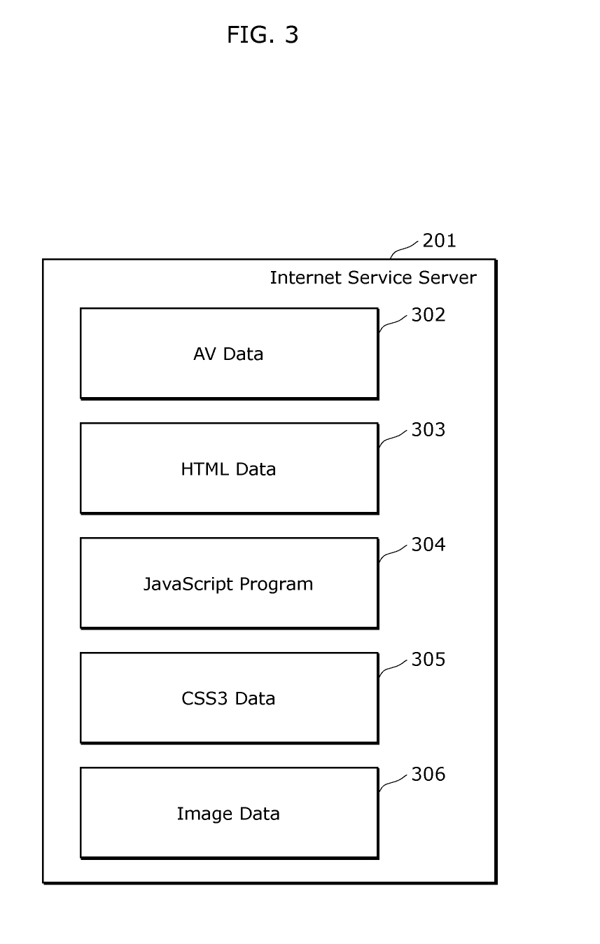

FIG. 3 is a diagram for explaining pieces of data stored in the Internet service server 201 according to the present embodiment.

The Internet service server 201 has an internal memory that holds Audio/Visual (AV) data 302, HTML data 303, JavaScript® (hereinafter, ® mark is omitted) program 304, CSS3 data 305, and image data 306. The Internet service server 201 transmits each of the pieces of data to the reproduction device 101 via the network.

The AV data 302 is paid video data or paid audio data. The user is charged to buy or rent to perceive the AV data 302 by the reproduction device 101. It should be noted that the AV data 302 may be free video data or free audio data.

The HTML data 303 is data described by HTML that is a markup language defined for describing Web pages. By using a tool for interpreting HTML of a browser and displaying HTML data, data described in HTML is expressed with a high visibility.

The JavaScript program 304 is a program described in a programming language, JavaScript. The JavaScript program 304 is downloaded to the reproduction device 101 and executed by the reproduction device 101. The JavaScript program 304 is capable of dynamically changing the HTML data 303. Therefore, by executing the JavaScript program 304, it is possible to change a motion, a color, a style (described later), and the like of each of elements (described later) in the HTML data 303 while the user is watching the HTML data 303 through the browser.

The CSS3 data 305 is style data created according to CSS3 specifications. A style refers to an instruction as to how to decorate an element described in HTML. An element refers to a minimum unit between tags in the HTML data. In generally, an element is a character sequence or image. For example, if CSS3 designates a style for an element that is defined by HTML to be displayed on the center of the screen, it is possible to instruct vertical scrolling of the element. While HTML determines a basic structure that does not have motion unlike the elements, CSS3 determines how to decorate each of the elements defined by HTML. For example, CSS3 instructs a color change, a motion, and the like for a target element. In this description, it is assumed that an element, image, and a character sequence mean data of the element (element data), data of the image (image data), and data of the character sequence (character sequence data), respectively.

The image data 306 is image data used in the HTML data 303. The image data 306 is often compressed by a format such as Joint Photographic Experts Group (JPEG) or Portable Network Graphics (PNG).

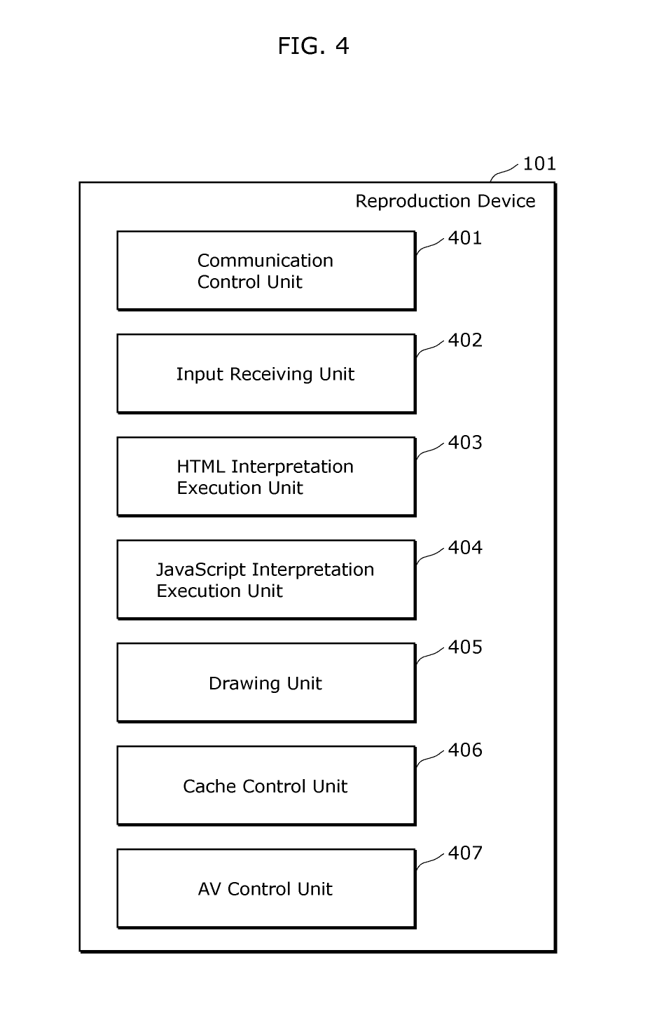

FIG. 4 is a functional block diagram of the reproduction device 101 according to the present embodiment.

The reproduction device 101 includes a communication control unit 401, an input receiving unit 402, an HTML interpretation execution unit 403, a JavaScript interpretation execution unit 404, a drawing unit 405, a cache control unit 406, and an AV control unit 407. The communication control unit 401 receives data from the Internet service server 201. If the received data is the HTML data 303 and the CSS3 data, the communication control unit 401 provides the data to the HTML interpretation execution unit 403. If the received data is the JavaScript program 304, the communication control unit 401 provides the data to the JavaScript interpretation execution unit 404. If the received data is the AV data 302, the communication control unit 401 provides the data to the AV control unit 407. If the received data is the image data 306, the communication control unit 401 provides the data to the drawing unit 405.

The input receiving unit 402 receives instruction data that is transmitted by the user from the remote controller 102, and provides the instruction data to the JavaScript interpretation execution unit.

The HTML interpretation execution unit 403 receives the HTML data 303 and the CSS3 data 305, and then interprets the HTML data 303 to calculate a color, an arrangement position, and the like for each of the elements in the HTML data 303, and interprets the CSS3 data 305 to calculate a decoration method to be applied to each of the elements. The HTML interpretation execution unit 403 provides the respective calculation results to the drawing unit 405.

The JavaScript interpretation execution unit 404 receives the instruction data received by the input receiving unit 402, and executes a part of the JavaScript program according to the instruction data.

The drawing unit 405 receives the image data 306 from the communication control unit 401. If the image data 306 is compressed data, the drawing unit 405 decompresses the image data 306. According to the calculation results provided from the HTML interpretation execution unit 403, the drawing unit 405 draws elements in the HTML data 303 onto the screen (browser) to allow the user to see the elements.

More specifically, the HTML interpretation execution unit 403, the JavaScript interpretation execution unit 404, and the drawing unit 405 function as a drawing processing unit that draws pieces of element data onto the screen according to the instruction data received from the Internet service server 201. The instruction data includes the pieces of element data and instructs drawing of the pieces of element data. If the instruction data instructs application of decoration (decoration method) to the pieces of element data to be drawn, the drawing processing unit applies the decoration instructed in the instruction data to the image data stored in a memory (described below), and draws the decorated image data onto the screen.

When the drawing unit 405 draws image onto the screen, the cache control unit 406 controls a method of caching image data to effectively draw the image. More specifically, when the instruction data instructs application of decoration (decoration method) to pieces of element data to be drawn, the cache control unit 406 generates one piece of image data that includes the pieces of element data which keep their positional relationships as drawn, and writes the generated image data into the memory. The cache control unit 406 is a newly added structural element in the present disclosure. Therefore, the cache control unit 406 will be described in more detail with its operation example.

The AV control unit 407 receives the AV data 302 from the communication control unit 401, and then performs control, such as reproduction and stopping, on the AV data 302 according to the instructions from the JavaScript interpretation execution unit 404. Since the AV control unit 407 is not essential to the present disclosure, the AV control unit 407 is not described in detail.

It should be noted that each of the functions in the reproduction device 101 may be implemented as software or hardware.

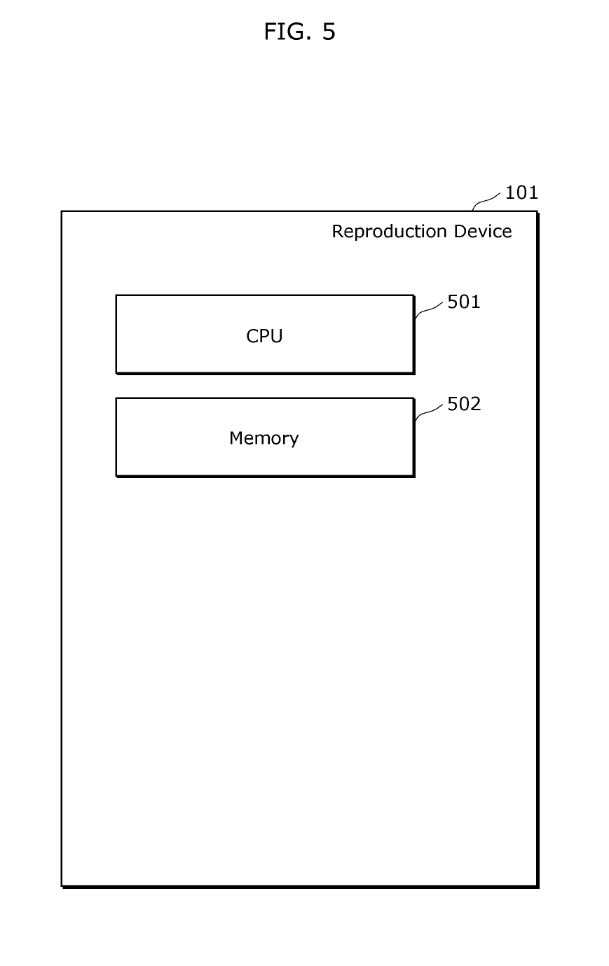

FIG. 5 is a block diagram showing a hardware structure of the reproduction device 101 according to the present embodiment.

The reproduction device 101 includes a Central Processing Unit (CPU) 501 and a memory 502.

The CPU 501 is a central processing device in the reproduction device 101. The CPU 501 runs a program for operating each of the processing units shown in FIG. 4. By running the program, the reproduction device 101 can function as an apparatus having the structure shown in FIG. 4.

The memory 502 is a volatile recording medium. The CPU 501 can read data from and write data into the memory 502. The memory 502 holds intermediate data, when the CPU 501 operates each of the structural elements shown in FIG. 4. The memory 502 also holds image data that is generated by decompressing the image data 306 that is compressed by JPEG or PNG.

Next, the processing according to the present embodiment is described.

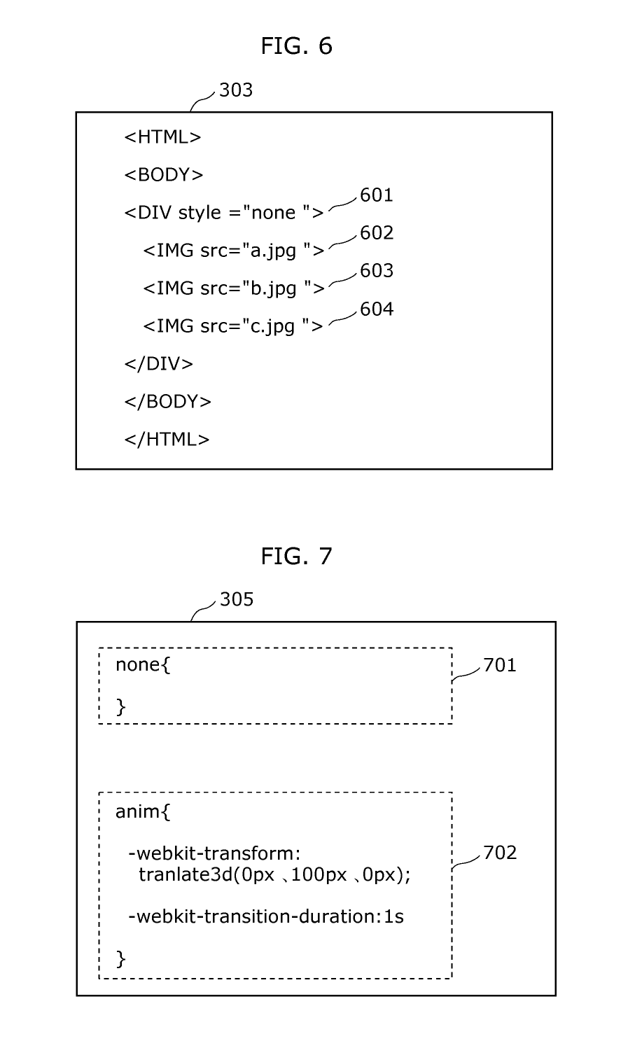

FIG. 6 is a diagram showing an example of the HTML data 303. For the sake of easy understanding, FIG. 6 shows parts relating to the present disclosure in detail, and shows the other parts simply.

<HTML> and <BODY> are tags indicating start of a piece of HTML data, and </BODY> and </HTML> are tags indicating end of the pieces of HTML data. Since the tags are not essential to the present disclosure, they are not described in detail.

A DIV tag 601 is used to indicate a part from <DIV> to </DIV> as one block. <DIV style=“none”> means that “none” is indicated as a style. The style “none” is designated to all the elements designated by all IMG tags 602, 603, and 604 between <DIV> to </DIV>.

The IMG tags 602, 603, and 604 each indicated as <IMG> are tags for drawing respective pieces of image (hereinafter, image elements) onto the screen. For example, src=“a.jpg” in the IMG tag 602 indicates to draw an image element having a file name “a.jpg” onto the screen.

FIG. 7 is a diagram showing an example of the CSS3 data 305.

A CSS3 style 701 has a style name “none” and no indication between brackets, which means no decoration method is designated. More specifically, if style=“none” is designated in a tag in the HTML data, it means that no decoration is to be applied to an image element belonging to the tag.

A CSS3 style 702 has a style name “anim”, and a property “-webkit-transform” and a property “-webkit-transition-duration” between brackets, which means that a decoration method is designated. First, “-webkit-transform” is explained. “-webkit-transform” indicates to move or transform a target image element. translate3d following “-webkit-transform” means that the target image element is to be moved. Furthermore, (0 px, 100 px, 0 px) are indicated after translated. These three numbers indicate a move amount in x direction (width direction), a move amount in y direction (height direction), and a move amount in z direction (depth direction), respectively. More specifically, in this case, the target image element is to move by 100 pixels in y direction (px stands for pixel). Next, “-webkit-transition-duration” is explained. “-webkit-transition-duration” designates a time required for the move. following “-webkit-transition-duration” means that the move takes one second (s stands for second). In short, if style is designated as “anim”, animation display of a target image element is performed by moving the target image element by 100 pixels in y direction for one second. How many times the target image element is to be drawn during the move is determined according to the capability of the reproduction device 101. Therefore, if the reproduction device 101 has a high hardware capability to efficiently execute software processing, the target image element is drawn many times during scrolling so that the user perceives the image element as moving smoothly. As a result, the user can feel comfortable in operating the reproduction device 101. On the other hand, if the reproduction device 101 has a low hardware capability and software processing is performed inefficiently, the target image element is not drawn many times during scrolling so that the user perceives the image element as moving awkwardly. As a result, the user is not comfortable in operating the reproduction device 101.

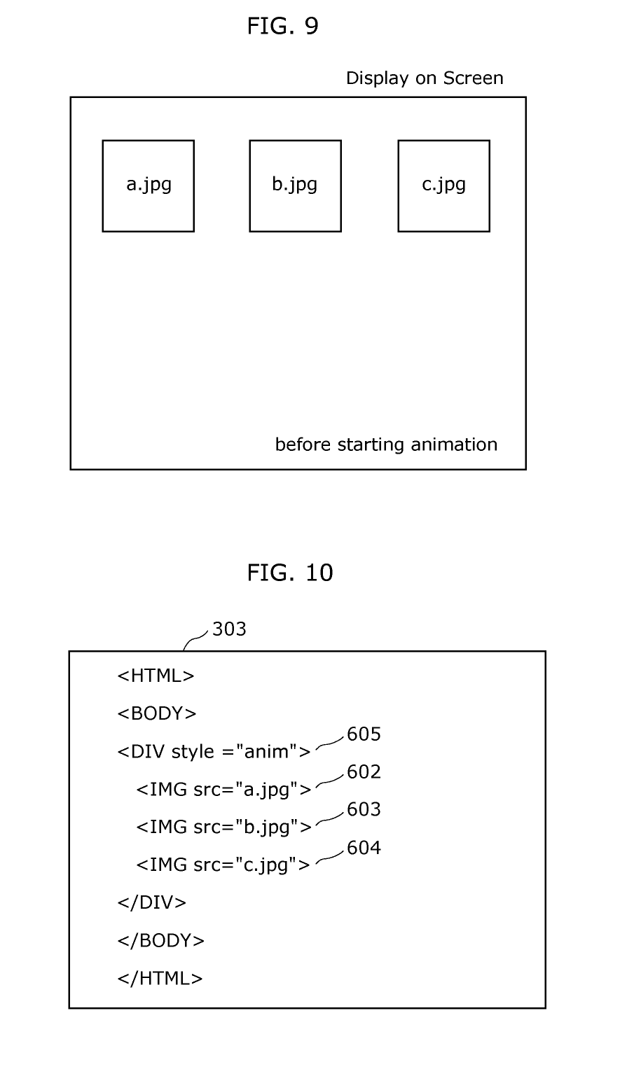

FIG. 9 is a diagram showing an example of displaying, on the screen, the HTML data 303 shown in FIG. 6. In the browser, an image file (image element) “a.jpg” designated by the IMG tag 602, an image file (image element) “b.jpg” designated by the IMG tag 603, and an image file (image element) “c.jpg” designated by the IMG tag 604 are displayed in order from the left.

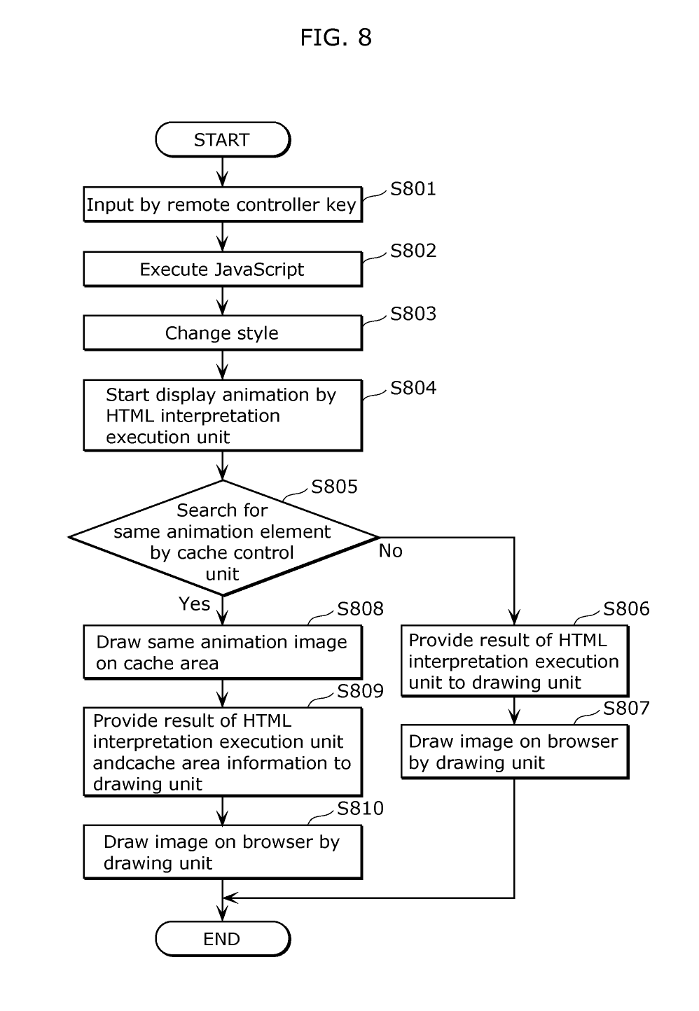

Next, with reference to FIG. 8, the description is given for an operation from when JavaScript instructs change of a style of the DIV tag 601 in the state of FIG. 9 thereby starting animation display until when the prior drawing step is performed. Hereinafter, the cache control unit 406 newly added in the present disclosure also performs its operation. The addition of the cache control unit 406 makes it possible to efficiently execute software processing, and increase the number of drawing operations during animation display, thereby allowing the user to feel comfortable in operations.

First, the user performs an operation by using the remote controller 102. It is assumed that, when the user presses a downward button of the remote controller 102, a program for changing a style of the JavaScript program 304 is executed. The input receiving unit 402 in the reproduction device 101 receives the user's input from the remote controller 102, and notifies the input to the JavaScript interpretation execution unit 404 (S801).

When the JavaScript interpretation execution unit 404 is notified of that the downward button of the remote controller 102 is pressed, the JavaScript interpretation execution unit 404 searches for a program to be executed when the downward button is pressed, and then executes the searched-out program (S802).

By executing the program, the style of the DIV tag 601 in the HTML data 303 is changed from “none” to “anim”, thereby changing the DIV tag 601 to a DIV tag 605. The resulting HTML data 303 is shown in FIG. 10 (S803).

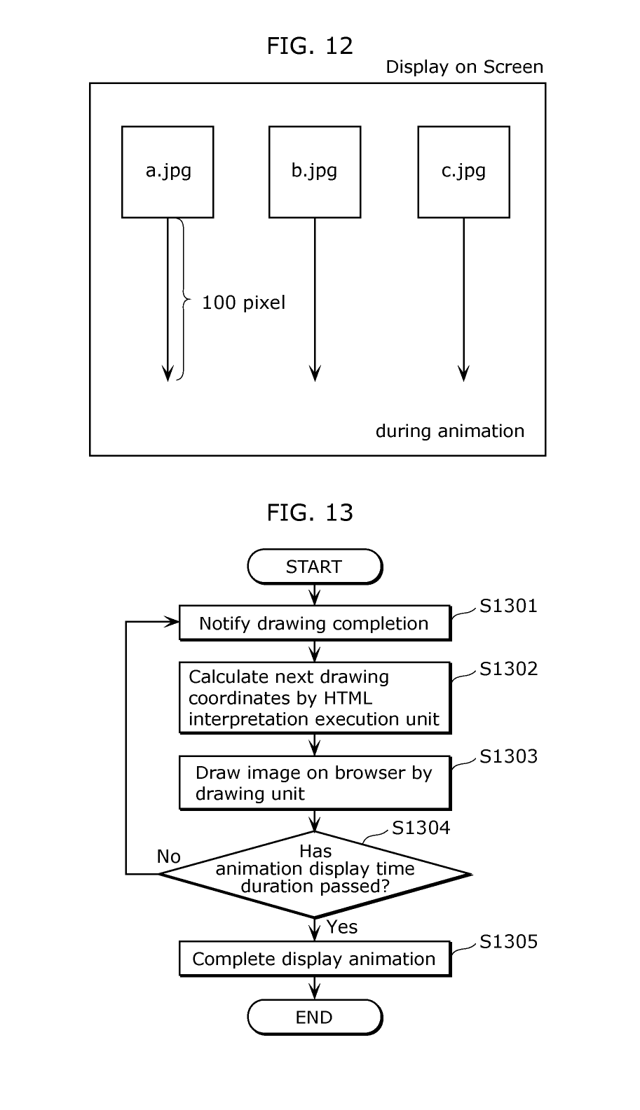

Next, when the HTML interpretation execution unit 403 is notified from the JavaScript interpretation execution unit 404 of that the style of the DIV tag 601 has been changed, the HTML interpretation execution unit 403 interprets the style “anim” designated in the DIV tag 601 with reference to the CSS3 data 305 in FIG. 7. In more detail, the HTML interpretation execution unit 403 interprets that animation display is to be performed by moving each target image element by 100 pixels in y direction for 1 second, and therefore starts the animation display (S804). For the sake of easy understanding, FIG. 12 shows a display example in the state where the animation display starts.

Next, the cache control unit 406 searches for pieces of image (image elements) to be applied with the same animation display. In this case, since the style is designated to the DIV tag 601, it is possible to determine that the same animation display is to applied to (a) the image element (having the file name a.jpg) designated by the IMG tag 602, (b) the image element (having the file name b.jpg) designated by the IMG tag 603, and (c) the image element (having the file name c.jpg) designated by the IMG tag 604, all of which are grouped together by <DIV> in the DIV tag 601. Therefore, the cache control unit 406 determines that the three pieces of image element data (the three image elements) are to be cached as a single piece of image data (Yes at S805), and then proceeds to S808. If it is determined that there is no image element to be applied with the same animation display (No at S805), then the processing proceeds to S806 to skip the cache operation. Then, the calculation results of the HTML interpretation execution unit 403 are provided to the drawing unit 405 (S806). The drawing unit 405 issues drawing instructions for the respective image elements to the screen, so as to draw the image elements (S807).

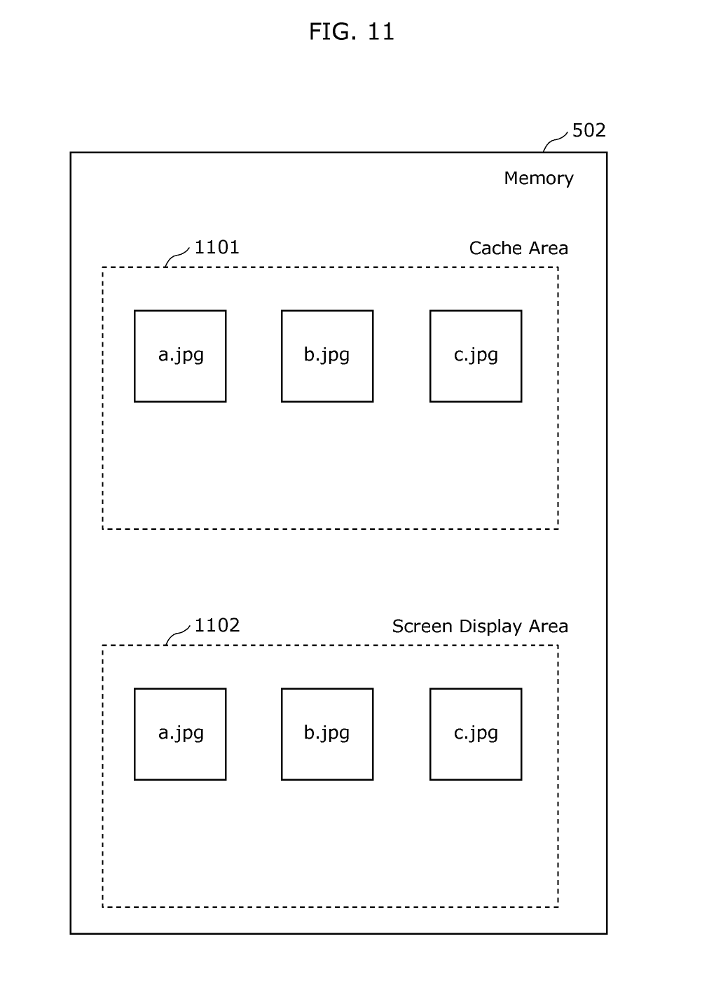

If it is determined that there are pieces of image element data (image element) to be cached as a single piece of image data (Yes at S805), then the cache control unit 406 instructs the drawing unit 405 to draw (a) the image element (having the file name a.jpg) designated by the IMG tag 602, (b) the image element (having the file name b.jpg) designated by the IMG tag 603, and (c) the image element (having the file name c.jpg) designated by the IMG tag 604, in a cache area in the memory 502 so that the image elements are arranged in the same manner as drawn on the screen. Receiving the instruction, the drawing unit 405 draws the three pieces of image element data on the cache area (S808). More specifically, by the above processing, the cache control unit 406 generates a single piece of image data that includes three image elements having the same positional relationships as drawn, and writes the generated single piece of image data into the cache area in the memory 502. FIG. 11 is a diagram showing an example of the resulting data stored in the memory 502. The cache area in the memory 502 holds the single piece of image data 1101 that includes the three image elements. More specifically, when the instruction data instructs application of the same decoration to all pieces of the element data, the cache control unit 406 generates one piece of image data that includes the pieces of element data which keep the same positional relationships as drawn, and writes the generated piece of image data into the memory 502.

Next, the drawing unit 405 receives the calculation results from the HTML interpretation execution unit 403, and receives, from the cache control unit 406, cache information indicating which image is cached in which cache area in the memory 502 (S809). For example, the cache information includes (a) information indicating which pieces of image or character elements are cached as a single piece of image data in which cache area (for example, information indicating that image elements a.jpg, b.jpg, and c.jpg are cached as a single piece of image data in a certain cache area), and (b) start address information of each cache area.

Finally, the drawing unit 405 draws, on the screen, the single piece of image data 1101 stored in the corresponding cache area in the memory 502 (S810). More specifically, the drawing unit 405 writes the single piece of image data 1101 stored in the cache area in the memory 502 to a screen display area as a single piece of image data 1102, thereby drawing the single piece of image data 1101.

Next, drawing steps following the above drawing (hereinafter, referred to as a “prior drawing step”) are described with reference to the flowchart of FIG. 13.

First, the HTML interpretation execution unit 403 is notified from the drawing unit 405 of that the prior drawing step has completed (S1301).

Then, the HTML interpretation execution unit 403 calculates coordinates to which the target image element having drawn in the prior drawing step is to be drawn next, based on (a) cache information that is received from the cache control unit 406 and indicates which pieces of image element data are cached as a single piece of image data (targets stored as a piece of image data in a cache area in the memory 502), (b) a present time, (c) a move distance of each of the target image elements to be applied with animation display designated by “-webkit-transform”, and (d) a time required for animation display designated by “-webkit-transition-duration”. More specifically, if (b) regarding the present time, it has passed 0.1 second since the animation display starts, (c) the move distance of each of the target image elements in the animation display is 100 pixels in y direction, and (d) the time required for the animation display is 1 second, the HTML interpretation execution unit 403 determines, according to a calculation formula 0.1/1×100, that coordinates to which each of the target image elements is to be drawn next is 10 pixels below in y direction since the time of starting the animation display (S1302).

Next, the drawing unit 405 obtains the results of calculating the drawing coordinates (a position away by 10 pixels in y direction) from the HTML interpretation execution unit 403 and obtains, from the cache control unit 406, cache information indicating which pieces of image elements are drawn as a single piece of image data in which cache area in the memory 502, thereby drawing the single piece of image data onto the screen (S1303).

Next, the HTML interpretation execution unit 403 determines whether or not the time which is designated by “-webkit-transition-duration” as a time required for the animation display has passed (S1304). If the time has already passed (Yes at S1304), then the HTML interpretation execution unit 403 terminates the animation display (S1305). On the other hand, if the time has not yet passed (No at S1304), then the processing returns to S1301.

More specifically, when the instruction data instructs application of the same decoration to all pieces of element data, the drawing processing unit applies the decoration to the piece of image data stored in the memory 502, and draws the decorated piece of image data onto the screen.

Without caching, it is necessary to draw three image elements (a.jpg, b.jpg, c.jpg) independently every time drawing is performed on the browser (in other words, three drawing operations are necessary for each browser drawing). However, in the present embodiment, the cache control unit 406 is provided to use caching, so that it is necessary, as the prior drawing step, to draw three image elements to the cache area as a single piece of image data and also draw the single piece of image data stored in the cache area to the browser. As a result, totally four drawing operations are necessary. However, in each of drawing steps after the prior drawing step, it is necessary only to draw the single piece of image data stored in the cache area to the browser during animation display. This means that only one drawing operation is necessary in each of drawing steps after the prior drawing step. As a result, the capability is significantly increased. It should be noted that it has been described in the present embodiment that a single piece of image data includes three image elements, but the present embodiment is not limited to the above. If a single piece of image data includes three or more image elements and the same animation display is applied to all the image elements, more improvement can be offered.

It should also be noted that it has been described above that a plurality of image elements are indicated in the same <DIV> block (block between <DIV> and </DIV>), and the cache control unit 406 determines at S805 that all the image elements belonging to the <DIV> block are to be cached as a single piece of image data because a style is applied to the <DIV> block. However, there are other various methods of determining targets to be cached as a single piece of image data. The following describes such determination methods.

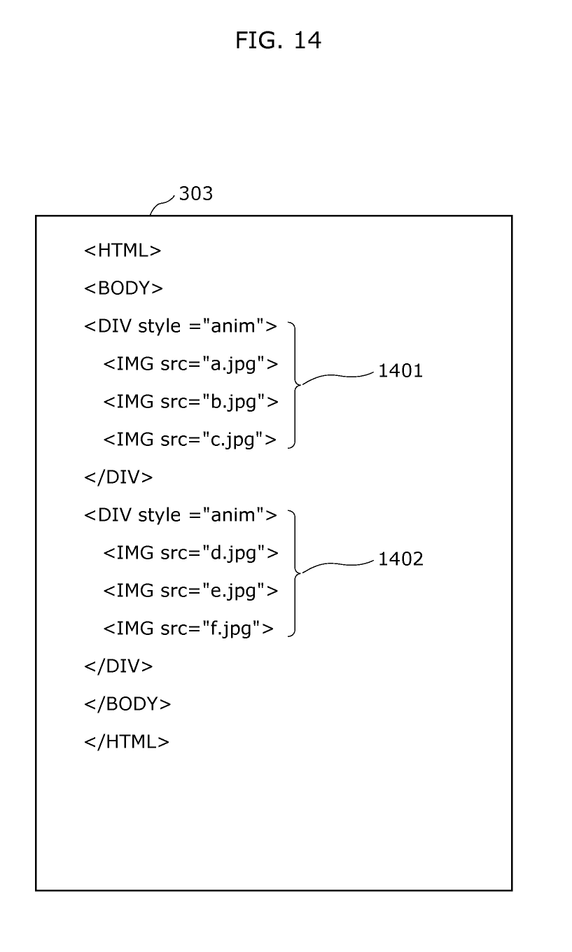

As shown in FIG. 14, the HTML data 303 includes two <DIV> blocks; a <DIV> block 1401 and a <DIV> block 1402. If the same style “anim” is designated in both the blocks, it is possible to determine that pieces of image element data having file names a.jpg, b.jpg, c.jpg, d.jpg, e.jpg, and f.jpg are to be cached as a single piece of image data in the same cache area. In the above example, a style is designated to a <DIV> tag. However, there is a case where a style is designated not to the <DIV> tag, but to each of <IMG> tags. If the same styles is designated to each of <IMG> tags, it is possible to determine that the image elements are to be cached as a single piece of image data in the same cache area. It should be noted that tags to which a style is designated are not limited to <DIV> tags and <IMG> tags. It is possible to designate a style to any tag in the HTML data.

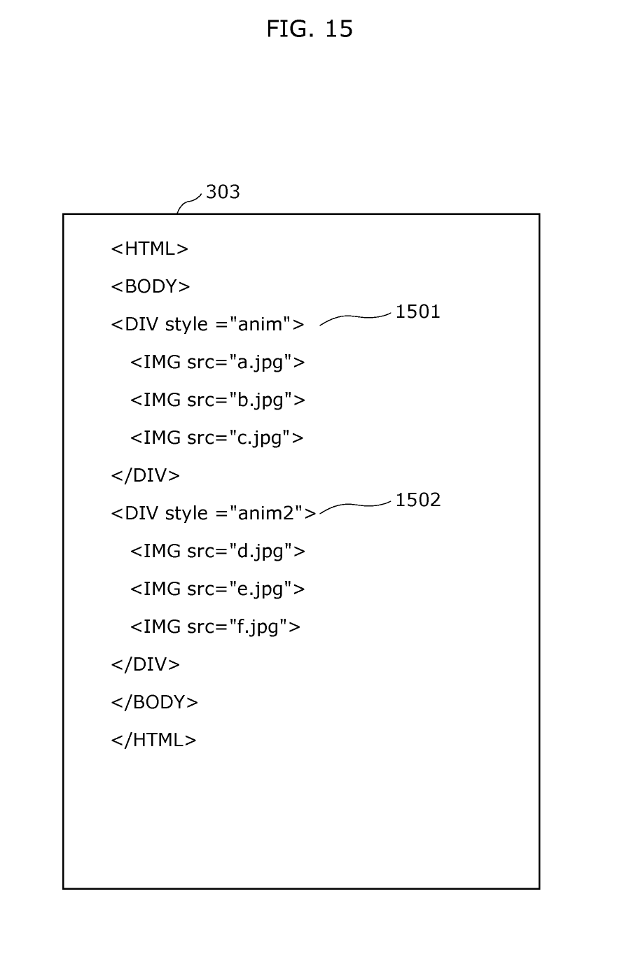

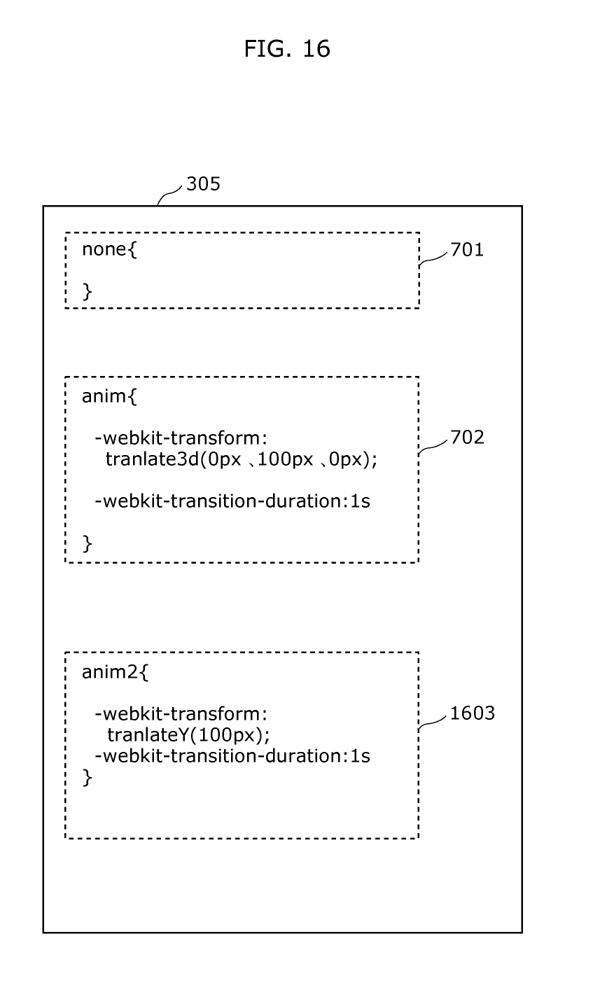

Furthermore, even if the same style is not designated to all elements, there is a case where it is possible to determine to cache the elements as a single piece of image data. More specifically, if elements are designated with respective different styles but keep relative positions among them, such elements can be determined to be cached as a single piece of image data. More specifically, if image elements, which are designated to move to x, y, and z coordinates by modules, such as translate, translateX, translateY, translateZ, and translate3d, of the property “-webkit-transform” for managing move, have the same “move width of coordinates” and the same “time required for move”, relative positions among the image elements are not changed. It is therefore possible to determine to cache, as a single piece of image data, such image elements keeping the relative positions unchanged. More specifically, if respective styles designate move of image elements but the move does not change positional relationships (relative positions) of the image elements, the single piece of image data 1101 having displaced coordinates is written as the single piece of image data 1102 into the screen display area of the memory 502 when the single piece of image data 1101 cached in the memory 502 is to be drawn on the screen. Thereby, the single piece of image data 1101 can be used again later. An example of the above case is described with reference to FIGS. 15 and 16. FIG. 15 is a diagram showing an example of the HTML data. FIG. 16 is a diagram showing an example of the CSS3 data. With reference to FIG. 15, the HTML data 303 includes two DIV tags; a DIV tag 1501 and a DIV tag 1502. The DIV tags 1501 and 1502 are designated with different styles. A style having a style name “anim” is designated to the DIV tag 1501, while a style having a style name “anim2” is designated to the DIV tag 1502. The details of the styles are defined in the CSS3 data 305 in FIG. 16. The CSS3 styles 701 and 702 are the same as shown in FIG. 7. That is, the CSS3 style 701 having the style name “none” indicates that there is no decoration method to be applied. The CSS3 style 702 having the style name “anim” designates, by using the module translate3d, a move to coordinates, namely, “move by 100 pixels in y direction for one second”. A CSS3 style 1603 having the style name “anim2” designates, by using the module translateY, the same coordinate move as the CSS3 style 702, namely, “move by 100 pixels in y direction for one second”. As described above, the DIV tags 1501 and 1502 are designated with respective different styles, but share the same style designation of the coordinate move and the time required for the move. Therefore, image elements having file names “a.jpg”, “b.jpg”, “c.jpg”, “d.jpg”, “e.jpg”, and “f.jpg” designated by respective IMG tags included in the two blocks designated by the respective DIV tags 1501 and 1502 are determined as being able to be cached as a single piece of image data 1101 to the same cache area. It should be noted that it has been described in the above example that a move in y direction is designated, but it is also possible to designate a move in x direction, a move in z direction, or a move in a direction combining the above directions.

More specifically, in the case where positional relationships among plural pieces of element data are not changed when different decoration methods instructed by respective pieces of instruction data are applied to respective pieces of element data in a drawing operation, the cache control unit 406 generates one piece of image data that includes the plural pieces of element data which keep the same positional relationships as drawn, and writes the generated piece of image data into the memory 502. Furthermore, in the case where positional relationships among plural pieces of element data are not changed when different decoration methods instructed by respective pieces of instruction data are applied to respective pieces of element data in a drawing operation, the drawing processing unit applies any one of the decoration methods instructed for the pieces of element data to the piece of image data stored in the memory 502, and draws the decorated piece of image data onto the screen.

More specifically, if the pieces of instruction data instruct application of decoration methods to the respective pieces of element data by performing parallel translation on them with the same move width and with the same time duration required for the move, the cache control unit 406 generates one piece of image data that includes the pieces of element data which keep the same positional relationships as drawn, and writes the generated piece of image data into the memory 502. Furthermore, if the pieces of instruction data instruct application of decoration methods to the respective pieces of element data by performing parallel translation on them with the same move width and with the same time duration required for the move, the drawing processing unit applies any one of the decoration methods instructed for the pieces of element data to the piece of image data stored in the memory 502, and draws the decorated piece of image data onto the screen.

It is also possible to determine that a plurality of image elements are to be cached as a single piece of image data, if modules, such as scale, scaleX, scaleY, and scale3d, in the property “-webkit-transform” are used to designate image scaling (size increase or size decrease of a target image element), and different styles instruct to decorate respective image elements by scaling them only in x direction, but the different styles designate the same “y coordinates of target image element” and the same “time required for scaling”. It is further possible to determine that a plurality of image elements are to be cached as a single piece of image data, if different styles instruct to decorate respective image elements by scaling them only in y direction, but the different styles designate the same “x coordinates of target image element” and the same “time required for scaling”.

More specifically, if the pieces of instruction data instruct application of decoration methods to the respective pieces of element data by scaling them in the same coordinate axis direction for the same time duration, the cache control unit 406 generates one piece of image data that includes the plural pieces of element data which keep the same positional relationships as drawn, and writes the generated piece of image data into the memory 502. Furthermore, if the pieces of instruction data instruct application of decoration methods to the respective pieces of element data by scaling them in the same coordinate axis direction for the same time duration, the drawing processing unit applies any one of the decoration methods instructed for the pieces of element data to the piece of image data stored in the memory 502, and draws the decorated piece of image data onto the screen.

It is also possible to determine that a plurality of image elements are to be cached as a single piece of image data, if modules, such as rotate, rotateX, rotateY, rotateZ, and rotate3d, in the property “-webkit-transform” are used to designate image rotation, and different styles instruct to decorate respective image elements by rotating them with respect to the x-coordinates, but the different styles designate the same “x coordinates around which the image elements are to be rotated” and the same “time required for rotation”. This is because such rotation does not change relative positions among the image elements. It is further possible to determine that a plurality of image elements are to be cached as a single piece of image data, if different styles instruct to decorate respective image elements by rotating them with respect to the y coordinates, but the different styles designate the same “y coordinates around which the image elements are to be rotated” and the same “time required for rotation”. This is because such rotation does not change relative positions among the image elements. It is still further possible to determine that a plurality of image elements are to be cached as a single piece of image data, if different styles instruct to decorate respective image elements by rotating them with respect to the z coordinates, but the different styles designate the same “z coordinates around which the image elements are to be rotated” and the same “time required for rotation”. This is because such rotation does not change relative positions among the image elements.

More specifically, if the pieces of instruction data instruct application of decoration methods to the respective pieces of element data by rotating them with respect to the same coordinates on the same coordinate axis for the same time duration, the cache control unit 406 generates one piece of image data that includes the plural pieces of element which keep the same positional relationships as drawn, and writes the generated piece of image data into the memory 502. Furthermore, if the pieces of instruction data instruct application of decoration methods to the respective pieces of element data by rotating them with respect to the same coordinates on the same coordinate axis for the same time duration, the drawing processing unit applies any one of the decoration methods instructed for the pieces of element data to the piece of image data stored in the memory 502, and draws the decorated piece of image data onto the screen.

Thus, examples of criterion to determine to cache image elements as a single piece of image data have been described above. However, it is also possible to determine to cache, as a single piece of image data, image elements which are to be applied with other different animation display, as long as relative positions among the image elements are not changed during the animation display. In other words, it is possible to determine to cache image elements, if moving, scaling, or rotating of the single piece of image data 1101 cached in the cache area of the memory 502 can generate a piece of image which is designated by the HTML data and the CSS3 data to be drawn next.

According to the present embodiment, displaying, on a screen, one piece of image data stored in a memory can result in the same piece of image data as generated by displaying plural pieces of image element data independently on the screen. A decoration operation is performed only once by decorating a single piece of image data. As a result, it is possible to draw plural pieces of image element data at a high speed. It is therefore possible to achieve smooth animation display, when animation display is performed for pieces of image element data in an HTML browser by using CSS3 or the like. As a result, a usability is improved.

Furthermore, if the same decoration is designated by instruction data to all of plural pieces of element data, the decoration is applied to one piece of image data stored in the memory only once. This results in the same image as generated by decorating the pieces of element data separately. It is therefore possible to decorate the pieces of element data at a high speed. As a result, it is possible to draw the pieces of element data at a high speed, thereby improving a usability.

Moreover, even if different pieces of instruction data designate different decoration methods to plural pieces of element data, as long as the decoration methods keep positional relationships among the pieces of element data unchanged, one piece of image data stored in the memory is decorated only once to generate the same image as generated by decorating the pieces of element data separately. It is therefore possible to decorate the pieces of element data at a high speed. As a result, it is possible to draw the pieces of element data at a high speed, thereby improving a usability.

Although the embodiment has been described above, the present disclosure is not limited to the embodiment.

For example, although it has been described in the embodiment that data for defining decoration to be applied to elements is the CSS3 data, the data is not limited to the CSS3 data in the present disclosure. More specifically, in the same manner as the CSS3 data, the data for defining decoration may be any data having a function of adding decoration, such as move, scaling, or rotation, to an element described in HTML data (element designated by an <IMG> tag in the HTML data) or to a group of such elements (elements designated by a <DIV> tag in the HTML data 303).

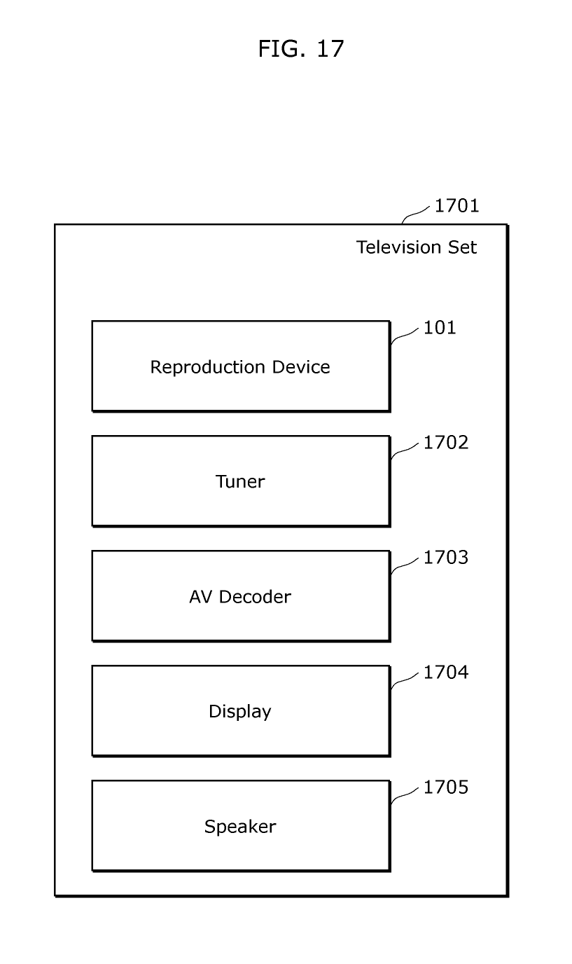

It should also be noted that it has been described in the present embodiment that the present disclosure is implemented to a player, but the present disclosure may be implemented to a television set. FIG. 17 shows an example of a functional structure of the television set.

The television set 1701 includes a reproduction device 101, a tuner 1702, an AV decoder 1703, a display 1704, and a speaker 1705.

The reproduction device 101 has a function of reproducing net service data which has been described in the above embodiment. The tuner 1702 receives broadcast signals and provides the received broadcast signals to the AV decoder 1703. The AV decoder 1703 decodes video data and audio data in the broadcast signal received by the tuner 1702. The display 1704 displays drawing data provided from the reproduction device 101 or the video data decoded by the AV decoder 1703. The speaker 1705 outputs sounds of the audio data decoded by the AV decoder 1703.

It should be noted that the device according to the above embodiment may be implemented as, for example, a computer system that includes a microprocessor, a ROM, a RAM, a hard disk drive, a display unit, a keyboard, a mouse, and the like. The RAM or the hard disk drive holds a computer program. The microprocessor operates according to the computer program, thereby causing the device according to the present embodiment to perform its functions. Here, the computer program is a combination of instruction codes each indicating instructions to the computer to execute a predetermined function.

It should be noted that a part or all of the structural elements included in the device according to the present embodiment may be implemented into a single Large Scale Integration (LSI). The system LSI is a super multi-function LSI that is a single chip into which a plurality of structural elements are integrated. More specifically, the system LSI is a computer system including a microprocessor, a ROM, a RAM, and the like. The RAM holds a computer program. The microprocessor operates according to the computer program to cause the system LSI to perform its functions.

It should also be noted that a part or all of the structural elements included in the device according to the present embodiment may be implemented into an Integrated Circuit (IC) card or a single module which is attachable to and removable from the device. The IC card or the module is a computer system including a microprocessor, a ROM, a RAM, and the like. The IC card or the module may include the above-described super multi-function LSI. The microprocessor operates according to the computer program to cause the IC card or the module to perform its functions. The IC card or the module may have tamper resistance.

It should also be noted that the present disclosure may be the above-described method. The present disclosure may be a computer program causing a computer to execute the method, or digital signals indicating the computer program.

It should also be noted that the present disclosure may be a non-transitory computer-readable recording medium on which the computer program or the digital signals are recorded. Examples of the computer-readable recording medium are a flexible disk, a hard disk, a Compact Disc (CD)-ROM, a magnetooptic disk (MO), a Digital Versatile Disc (DVD), a DVD-ROM, a DVD-RAM, a BD (Blue-ray® Disc), and a semiconductor memory. The present disclosure may be digital signals recorded on the non-transitory recording medium.

It should also be noted in the present disclosure that the computer program or the digital signals may be transmitted via an electric communication line, a wired or wireless communication line, a network represented by the Internet, data broadcasting, and the like.

It should also be noted that the present disclosure may be a computer system including a microprocessor operating according to the computer program and a memory storing the computer program.

It should also be noted that the program or the digital signals may be recorded onto the non-transitory recording medium to be transferred, or may be transmitted via a network or the like, so that the program or the digital signals can be executed by a different independent computer system.

It should also be noted that the above-described embodiment and its variation may be combined.

The disclosed embodiment is merely exemplary and do not limit the present disclosure. The scope of the present disclosure is indicated not by the above description but by the appended claims. Accordingly, all modifications are intended to be included within the same meanings and the scope of the claims.

### INDUSTRIAL APPLICABILITY

The present disclosure is applicable to CEs, such as mobile information terminals and tablet computers, television sets, and the like.

1. A reproduction device that reproduces pieces of element data to display the pieces of element data on a screen, the pieces of element data each being image data or character data, the reproduction device comprising:
a memory;
a drawing processing unit configured to draw pieces of element data onto the screen according to instruction data received from a server, the instruction data including the pieces of element data and instructing to draw the pieces of element data; and
a cache control unit configured to, when the instruction data instructs application of a decoration method to the pieces of element data to be drawn, (i) generate a piece of image data that includes the pieces of element data which keep a positional relationship between the pieces of element data as drawn, and (ii) write the generated piece of image data into the memory,
wherein the drawing processing unit is configured to, when the instruction data instructs application of the decoration method to the pieces of element data to be drawn, (i) apply the decoration method instructed in the instruction data to the piece of image data stored in the memory, and (ii) draw the decorated image data onto the screen.

2. The reproduction device according to claim 1,
wherein, when the instruction data instructs application of a same decoration method to all the pieces of element data, the cache control unit is configured to (i) generate one piece of image data that includes the pieces of element data which keep the positional relationship as drawn, and (ii) write the generated piece of image data into the memory, and
when the instruction data instructs application of the same decoration method to all the pieces of element data, the drawing processing unit is configured to (i) apply the same decoration method to the piece of image data stored in the memory, and (ii) draw the decorated pieces of image data onto the screen.

3. The reproduction device according to claim 1,
wherein, if the positional relationship between the pieces of element data is not changed when different decoration methods instructed in the instruction data are applied to the respective pieces of element data in drawing the pieces of element data, the cache control unit is configured to (i) generate one piece of image data that includes the pieces of element data which keep the positional relationship as drawn, and (ii) write the generated piece of image data into the memory, and
if the positional relationship between the pieces of element data is not changed when the different decoration methods instructed in the instruction data are applied to the respective pieces of element data in drawing the pieces of element data, the drawing processing unit is configured to (i) apply any one of the different decoration methods instructed for the pieces of element data to the piece of image data stored in the memory, and (ii) draw the decorated piece of image data onto the screen.

4. The reproduction device according to claim 3,
wherein, when the instruction data instructs application of decoration methods to the respective pieces of element data by performing parallel translation on the pieces of element data with a same move width and with a same time duration required for the move, the cache control unit is configured to (i) generate one piece of image data that includes the pieces of element data which keep the positional relationship as drawn, and (ii) write the generated piece of image data into the memory, and
when the instruction data instructs application of the decoration methods to the respective pieces of element data by performing the parallel translation on the pieces of element data with the same move width and with the same time duration required for the move, the drawing processing unit is configured to (i) apply any one of the decoration methods instructed for the pieces of element data to the piece of image data stored in the memory, and (ii) draw the decorated piece of image data onto the screen.

5. The reproduction device according to claim 3,
wherein, when the instruction data instructs application of decoration methods to the respective pieces of element data by scaling the pieces of element data in a same coordinate axis direction for a same time duration, the cache control unit is configured to (i) generate one piece of image data that includes the pieces of element data which keep the positional relationship as drawn, and (ii) write the generated piece of image data into the memory, and
when the instruction data instructs application of the decoration methods to the respective pieces of element data by scaling the pieces of element data in the same coordinate axis direction for the same time duration, the drawing processing unit is configured to (i) apply any one of the decoration methods instructed for the pieces of element data to the piece of image data stored in the memory, and (ii) draw the decorated piece of image data onto the screen.

6. The reproduction device according to claim 3,
wherein, when the instruction data instructs application of decoration methods to the respective pieces of element data by rotating the pieces of element data with respect to same coordinates on a same coordinate axis for a same time duration, the cache control unit is configured to (i) generate one piece of image data that includes the pieces of element data which keep the positional relationship as drawn, and (ii) write the generated piece of image data into the memory, and
when the instruction data instructs application of the decoration methods to the respective pieces of element data by rotating the pieces of element data with respect to the same coordinates on the same coordinate axis for the same time duration, the drawing processing unit is configured to (i) apply any one of the decoration methods instructed for the pieces of element data to the piece of image data stored in the memory, and (ii) draw the decorated piece of image data onto the screen.

7. A television set comprising:
the reproduction device according to claim 1;
a tuner that receives broadcast signals;
an AV decoder that decodes video data and audio data from the broadcast signals received by the tuner;
a display that displays the video data decoded by the AV decoder; and
a speaker that outputs the audio data provided from the AV decoder,
wherein the reproduction device draws the decorated image data onto the display.

8. A reproduction method of reproducing pieces of element data to display the pieces of element data on a screen, the pieces of element data each being image data or character data, the reproduction method comprising:
drawing pieces of element data onto the screen according to instruction data received from a server, the instruction data including the pieces of element data and instructing to draw the pieces of element data; and
generating, when the instruction data instructs application of a decoration method to the pieces of element data to be drawn, a piece of image data that includes the pieces of element data which keep a positional relationship between the pieces of element data as drawn, and writing the generated piece of image data into the memory,
wherein in the drawing, when the instruction data instructs application of the decoration method to the pieces of element data to be drawn, the decoration method instructed in the instruction data is applied to the piece of image data stored in the memory, and the decorated image data is drawn onto the screen.
